(19) United States
(12) Patent Application Publication
(10) Pub. No.: US 2010/0284291 A1
(43) Pub. Date: Nov. 11, 2010

(54) MOBILITY MANAGEMENT WITH DOWNLINK-ONLY WIRELESS NETWORKS

(75) Inventors: Michelle Perras, Montreal (CA); Catherine M. Livet, Montreal (CA); Guang Lu, Montreal (CA); Juan Carlos Zuniga, Montreal (CA)

Correspondence Address: VOLPE AND KOENIG, P.C.;DEPT. ICC, UNITED PLAZA, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/775,849

(22) Filed: May 7, 2010

Related U.S. Application Data
(60) Provisional application No. 61/176,655, filed on May 8, 2009.
(60) Provisional application No. 61/181,818, filed on May 28, 2009.
(60) Provisional application No. 61/182,874, filed on Jun. 1, 2009.

(51) Int. Cl. H04W 24/00; H04H 20/71

(52) U.S. Cl. 370/252; 370/312; 370/331

(57) ABSTRACT

A wireless transmit/receive unit (WTRU) may include a media application that receives data from a media server via a link on a downlink (DL) -only radio access network. The link on the DL-only radio access network may be handed over to a second DL-only radio access network. A mobility management server, such as a Media Independent Handover (MIH) server, may communicate with the WTRU via a second radio access network that is a bidirectional radio access network to facilitate the handover. MIH messages may include fields that relate to DL-only radio access technologies may be used to facilitate handover of a DL-only link. Further, MIH broadcast or multicast messages may be used to facilitate the handover of a DL-only link.

### CROSS REFERENCES TO RELATED APPLICATIONS

This application claims the benefit of U.S. Provisional Application No. 61/176,655, filed May 8, 2009, U.S. Provisional Application No. 61/181,818, filed on May 28, 2009, and U.S. Provisional Application No. 61/182,874, filed on Jun. 1, 2009, each of which is hereby incorporated by reference herein in its entirety.

### TECHNICAL FIELD

The disclosed subject matter relates to wireless communications.

### BACKGROUND

Media content, such as video and audio content, may be delivered to users via wireless networks. In some approaches for the delivery of media content, such as the third generation partnership program (3GPP) wideband code division multiple access (WCDMA) with Multimedia Broadcast Multicast Service (MBMS), a bidirectional wireless network is used. According to MBMS, media content is delivered via downlink (DL) channels on the network, while control data may be sent back to the network via uplink (UL) channels on the network.

Another approach to the delivery of media content involves the use of DL-only networks. Such approaches include Digital Multimedia Broadcasting (DMB), Digital Video Broadcasting (DVB), and MediaFLO technologies. In these approaches, media content is sent via dedicated DL-only wireless networks. These networks do not themselves include UL channels, and cannot carry control data back from users. To carry control data back from users, a separate wireless network that supports UL channels must be used.

As UL data may not be carried on a DL-only network, mobility in the context of DL-only networks presents a number of challenges. Current technologies in this context do not adequately address, for example, how mobility-related information should be communicated, how handover decisions should be made, how handover of DL-only links should be performed, or how broadcast and multicast groups should be defined. Accordingly, new technologies are required that address these shortcomings, as well as other shortcomings, in the current technologies.

### SUMMARY

A method for use in a wireless transmit/receive unit (WTRU) may include generating link status information related to conditions on a radio link on a downlink-only radio access network. The WTRU may send a link status information message to a mobility management server. The link status information message includes some link status information and may also include a field that indicates that the link status information relates to a downlink-only radio access network.

A WTRU may include a link layer component that is configured to generate link status information related to conditions on a radio link on a downlink-only radio access network. The WTRU may also include a transmitter configured to transmit a link status information message to a mobility management server. The link status information message may also include a field that indicates that the link status information relates to a downlink-only radio access network.

A method for use in a WTRU may include receiving media data from a media server via a link on a downlink-only radio access network. The WTRU may play the media data in a media application. The WTRU may receive a handover request message from a mobility management server. The handover request message may indicate that the WTRU should handover to a second radio access network. The handover request message may include configuration information that indicates how the media operation should be configured to play the media data if the media data is received via the second radio access network. The WTRU may perform a handover to the second radio access network, and may receive the media data from the media server via a link on the second radio access network. The WTRU may play the media data in the media application based on the configuration information.

### BRIEF DESCRIPTION OF THE DRAWINGS

A more detailed understanding may be had from the following description, given by way of example in conjunction with the accompanying drawings wherein:

FIG. 1 shows an example architecture for the communication of media data;

FIG. 2 shows an example architecture for the communication of media data;

FIGS. 3A-3B show an example method for the network-based handover of a DL-only link;

FIGS. 4A-4B show an example method for the WTRU-based handover of a DL-only link;

FIG. 5A shows a method for the communication of data that includes the use of a Media Independent Handover (MIH) broadcast or multicast message;

FIG. 5B shows another method for the communication of data that includes the use of a Media Independent Handover (MIH) broadcast or multicast message; and

FIG. 6 shows an example communications system that may be configured to implement the features shown in FIGS. 1-5.

### DETAILED DESCRIPTION

When referred to hereafter, the terminology “wireless transmit/receive unit (WTRU)” includes but is not limited to a user equipment (UE), a mobile station, a mobile terminal, a fixed or mobile subscriber unit, a pager, a cellular telephone, a personal digital assistant (PDA), a computer, or any other type of device capable of operating in a wireless environment. When referred to hereafter, the terminology “base station” includes but is not limited to a Node-B, a site controller, an access point (AP), or any other type of interfacing device capable of operating in a wireless environment. When referred to hereafter, the terminology “network node” includes but is not limited to an electronic device that is attached to a communications network and is capable of sending and/or receiving data.

When referred to hereafter, the terminology “link layer component” is a component that implements layer one and/or layer two functionality according to a Radio Access Technology (radio access technology). A link layer component may be implemented as one or more circuits, one or more software modules, one or more firmware modules, or as any combination of circuits, software modules, and/or firmware modules. A link layer component may be, for example, a transceiver or one or more components in a transceiver. As used herein, the terms “software module” and “firmware module” include, but are not limited to, an executable program, a function, a method call, a procedure, a routine or sub-routine, an object, a data structure, or one or more executable instructions. A “software module” or a “firmware module” may be stored in one or more computer-readable media.

When referred to hereafter, the terminology “mobility management function” is a component that implements at least some subset of mobility management functionality. Mobility management functionality includes but is not limited to: receiving, generating, and/or storing information relating to available heterogeneous access networks, their attributes, and/or link status over to the access networks; and providing commands to heterogeneous link layer components to perform handover and/or turn radio interfaces on or off. A mobility management function may be implemented as one or more circuits, one or more software modules, one or more firmware modules, or as any combination of circuits, software modules, and/or firmware modules. When referred to hereafter, a “mobility management server” is a mobility management function that is implemented in a network and performs functionality related to the management of mobility of one or more WTRUs. When referred to hereafter, a “Media Independent Handover (MIH) Function (MIHF)” or an “MIH server” may implement features described according to one or more of Institute of Electrical and Electronics Engineers (IEEE) 802.21, 802.21a, 802.21b, 802.21c, and/or other 802.21x standards. An MIH server is one example of a mobility management server, though the principles described herein are not limited to the user of an MIH server. A MIHF is one example of a mobility management function, though the principles described herein are not limited to the use of MIH or the MIHF.

Where referred to hereafter, the terminology “Service Access Point (SAP)” refers to any interface between two communicating entities. A SAP may be a conceptual and/or logical location at which communicating components may address each other. Alternatively or additionally, a SAP may be defined by a set of messages that specify the interactions between the entities that communicate using the SAP.

When referred to hereafter, the terminology “Downlink (DL)-only base station” refers to base station capable of transmitting data using a radio access technology that supports the communication of data on a DL (i.e. from the network to WTRU) but does not support the communication of data on an UL (i.e. from the WTRU to the network). Where referred to hereafter, the terminology “DL-only radio access network” refers to a radio access network that supports the communication of wireless data on a DL but does not support the communication of wireless data on an UL. A DL-only base station may transmit wireless data on a DL-only radio access network. When referred to hereafter, the terminology “DL-only data” refers to data communicated in a DL-only radio access network. Examples of DL-only data include but are not limited to data communicated according to Digital Multimedia Broadcasting (DMB), Digital Video Broadcasting (DVB), or MediaFLO technologies.

When referred to hereafter, the terminology “bidirectional base station” refers to a base station capable of transmitting wireless data using a radio access technology that supports both UL and DL communication of data. Where referred to hereafter, the terminology “bidirectional radio access network” refers to a radio access network that supports both UL and DL communication of wireless data. A bidirectional base station may transmit and/or receive data on a bidirectional radio access network.

When referred to hereafter, the terminology “media server” refers to a network node that is involved in the generation and/or control of media data for communication to one or more WTRUs. Example of media servers include servers that generate and control the video data communicated in DMB, DVB, and Media FLO systems.

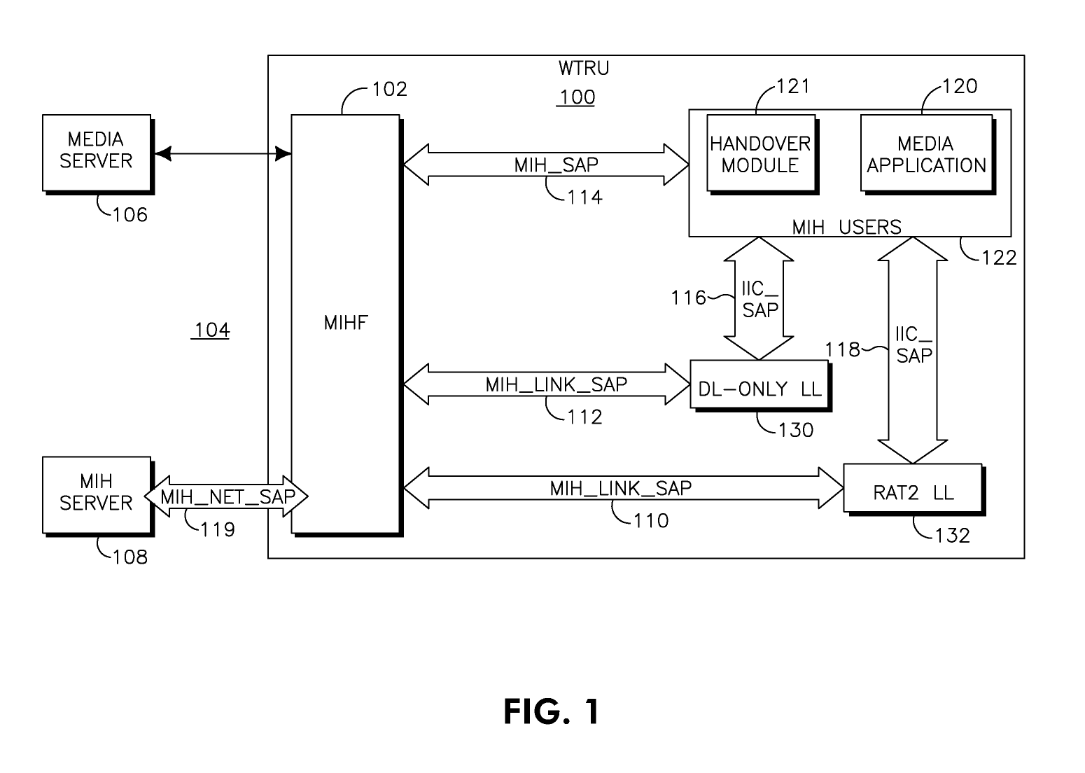

FIG. 1 shows an example architecture 104 for the communication of media data. The example architecture 104 includes an MIH server 108, a media server 106, and a WTRU 100.

The WTRU 100 includes a MIHF 102. The MIHF 102 implements three MIH services: the Media Independent Event Service (MIES), the Media Independent Information Service (MIIS), and the Media Independent Command Service (MICS). The MIES relates to the notification of events such as physical, data link and logical link layers state changes and establishment and tearing down of links. The purpose of the MIIS is to acquire a global view of available networks to facilitate network selection and handovers. The MIIS provides a mechanism for the exchange of information between MIH devices and MIH-capable networks regarding handover candidates. The MICS allows for the initiation of handover between links.

The WTRU 100 includes a first link layer component 130 that implements layer one and/or layer two functionality according to a DL-only radio access technology. A second link layer component 132 implements layer one and/or layer two functionality according to a second radio access technology that is a bidirectional radio access technology. As an example, the first link layer component 130 may function according to DMB, DBV, MediaFLO, or any other DL-only technology. The second link layer component 132 may function according to, for example, IEEE 802.11 Wireless Local Area Network (WLAN) or Third Generation Partnership Project (3GPP) Universal Mobile Telecommunications System (UMTS) Terrestrial Radio Access Network (UTRAN) standards. The MIHF 102 and the first link layer component 130 communicate via a first MIH_LINK_SAP 112. The MIHF 102 and the second link layer component 132 communicate via a second MIH_LINK_SAP 110. Each MIH_LINK_SAP 112, 110 may be implemented as a media-specific Media Access Control (MAC) SAP, physical layer (PHY) SAP, and/or Logical Link Control (LLC) SAP.

The WTRU 100 may receive media data from the media server 106 via a DL-only radio access network (not depicted) to which the DL-only link layer component 130 is connected.

The WTRU 100 includes MIH Users 122, which are entities that communicate with the MIHF102 using MIH_SAP 114. The MIH Users 122 may include a handover module 121. The handover module 121, as described in further detail below, may receive information from the MIHF 102 via the MIH_SAP 114 and use the information to make decisions regarding handover. The MIH Users 122 may communicate with the first link layer component 130 via a first Logical Link Control (LLC) SAP 116 and with the second link layer component 132 via a second LLC_SAP 118.

The MIH Users 122 further includes media application 120, which is configurable to receive and to play media data such as video and/or audio data. The media application 120 may receive media data from the media server 106 via the DL-only link layer component 130.

The MIHF 102 may communicate with an MIH server 108 via a network SAP (MIH_NET_SAP 119). The MIH_NET_SAP 119 may be implemented over a bidirectional radio access network, such as a network to which the second link layer component 132 is connected.

Entities such as, for example, the MIH Server 108 and/or the handover module 121, may register with the MIHF 102 to receive link status information related to the radio links provided by the DL-only link layer component 130 and/or the second link layer component 132. This link status information may indicate, for example, that a new link has gone up, that a link has gone down, that a link is going down, or that a handover is imminent or is complete. Further, the link status information may include periodic or event-triggered link parameter reports, or indicate the transmission status of protocol data units (PDUs). The DL-only link layer component 130 and the second link layer component 132 may provide this information to the MIHF 102 via MIH_LINK_SAPs 112, 110.

Upon receipt of the link status information, the MIHF 102 may communicate a corresponding message to the entities (such as the MIH Server 108 and/or the handover module 121) that have registered to receive the link status information. The MIHF 102 may do so using an MIH message such as a MIH_Link_Up.indication, MIH_Link_Down.indication, MIH_Link_Parameters_Report.indication, MIH_Link_Going_Down.indication, MIH_Link_Handover_Imminent.indication, MIH_Link_Handover_Complete.indication, MIH_Link_PDU_Transmit_Status.indication, or other MIH message. Each of these messages may include a LINK_TYPE field that indicates the type of link on which the event occurred. A LINK_TYPE field may indicate that the link involves the use of a broadcast technology or a DL-only technology. Alternatively or additionally, a LINK_TYPE field may indicate that the link involves the use of a specific broadcast or DL-only technology, such as DVB-H, DVB-T, or MediaFLO technology. Alternatively or additionally, the above-cited MIH messages may include a LINK_DIRECTION field. A LINK_DIRECTION field may hold one of three possible values: UL_ONLY, DL_ONLY, or BIDIRECTIONAL. When the MIHF 102 receives information from the DL-only link layer component 130 and generates the corresponding MIH message, the MIH message may include LINK_TYPE and/or LINK_DIRECTION fields that reflect the DL-only technology implemented by the DL-only link layer component 130.

The media application 120 may send one or more messages to the MIHF 102 that indicate link preferences or requirements expected by the media application 120. The messages may indicate, for example, an expected or preferred expected QoS, an expected or preferred bit rate, an expected or preferred latency, an expected or preferred radio access technology, and/or other preferences or requirements. For example, a media application 120 may indicate that it prefers a DVB-H or MediaFLO radio access network over a radio access network that uses MBMS for delivery of media content. This requirement information may be included as a field or Information Element (IE) in any message sent by the media application 120 to the MIHF 102, such as an MIH_Capability_Discover message, an MIH_Register message, an MIH_Event_Subscribe message, an MIH_Link_Get_Parameters message, an MIH_Link_Configure_Thresholds message, an MIH_Link_Actions message, or any other MIH message. Alternatively or additionally, this requirement information may be included in an MIH_Application_Info.indication message. Further, the MIHF 102 may query applications via the MIH_SAP 114 by sending an MIH_Application_Info.request message that indicates a request for requirement information. An application that receives an MIH_Application_Info.request may respond by sending an MIH_Application_Info.response message that indicates the application's requirement information.

The handover module 121 and/or the MIH Server 108 may base a handover determination on received application requirement information. The application requirement information may be received by entities such as, for example, the handover module 121 and/or the MIH Server 108, which may have registered with the MIHF 102 to receive the application requirement information. The application requirement information may be sent to the MIH Server 108 via the MIH_NET_SAP 119 and used by the MIH Server 108 to trigger a MIH Server 108 based handover (i.e., a network based handover). The application requirement information may be transmitted from the Media Application 120 to the MIHF 114. The application requirement information may be an expected bit rate for the Media Application 120, the preferred radio access technology and other similar information. For example, the handover module 121 and/or the MIH Server 108 may determine that a link that prefers or requires a DL-only radio access network (such as a DVB-H radio access network) should be handed over to another DL-only radio access network (such as a MediaFLO network) versus a bidirectional radio access network such a WLAN.

Alternatively or additionally, the handover module 121 and/or the MIH Server 108 may base a handover determination on LINK_TYPE and/or LINK_DIRECTION fields in an MIH message. For example, the handover module 121 and/or the MIH Server 108 may determine that the WTRU 100 should hand over from an access network of a particular type to a target access network of the same type.

If the MIH Server 108 or handover module 121 determine that a handover should be performed, they may communicate with the MIHF 102 to execute the handover. The MIH Server 108 may send, for example, a MIH_Net_HO_Commit.request message to the MIHF 102 to request that the WTRU 100 perform a handover. The handover module 121 may send a MIH_Link_Actions.request message to the MIHF 102 to request that the WTRU 100 perform a handover. Upon receipt of a MIH_Net_HO_Commit.request or MIH_Link_Actions.request message, the MIHF 102 may send corresponding primitives to the link layer components 130, 132 via the MIH_LINK_SAPs 112, 110.

As described above, the MIHF 102 may receive link status information from link layer components 130, 132 and generate corresponding MIH messages for communication to MIH Users 122. One such message is the MIH_Link_Parameters_Report.indication. The MIH_Link_Parameters_Report.indication may include a Sourceldentifier field that indicates an identifier of the MIHF that generated the MIH_Link_Parameters_Report.indication, a Linkldentifier field that indicates an identifier of the link associated with the MIH_Link_Parameters_Report.indication, and a LinkParameterReportList that includes a list of LINK_PARAM_RPT fields. Each LINK_PARAM_RPT field includes a LINK_PARAM field. Each LINK_PARAM field includes a LINK_PARAM_TYPE field and may include a LINK_PARAM_VAL field. The LINK_PARAM_TYPE field indicates the type of parameter that is included in the LINK_PARAM_VAL field; the LINK_PARAM_VAL includes the current value for the parameter. In the instance of a WTRU based handover, the handover module 121 may make the handover decision and either the handover module 121 and/or the Media Application 120 may communicate the handover decision directly. Alternatively or additionallu, the handover module 121 and/or the Media Application 120 may also share the information through the MIHF 102 with the MIH_SA 114.

When an MIHF 102 receives link status information from a link layer component that implements a DL-only radio access technology, the MIHF 102 may generate a corresponding MIH_Link_Parameters_Report.indication that includes a LINK_PARAM_RPT field that includes a LINK_PARAM field that includes a LINK_PARAM_TYPE field that indicates a DL-only parameter type. For example, the LINK_PARAM_TYPE field may have a LINK_PARAM_BROADCST value, and the LINK_PARAM_VAL field may indicate the corresponding value for the broadcast or DL-only parameter. In an instance where the link status information is received from a DBV-H link layer component, the LINK_PARAM_TYPE field may have a LINK_PARAM_DVB_H value, and the LINK_PARAM_VAL field may indicate the corresponding value for the DVB-H parameter. The DVB-H parameter value may relate to, for example, Network Information Table (NIT) information, Program Specific Information/Service Information (PSI/SI), or frame error rate (FER)/FMPE-FEC FER (MFER) information related to the link.

The MIHF 102 may communicate a MIH_Link_Parameters_Report.indication message that includes DL-only LINK_PARAM_TYPE and LINK_PARAM_VAL fields to registered entities (such as the MIH server 108 or the handover module 121) in the same way that it may communicate other MIH_Link_Parameters_Report.indication messages.

When a link layer component provides link status information to the MIHF 102, it may do so via an MIH_LINK_SAP, such as the MIH_LINK_SAP 110, 112 shown in FIG. 1. In an instance where a link layer component implements a broadcast radio access technology, it may provide link status information as indicated below in Table 1. Table 1 shows a mapping between broadcast radio information primitives and MIH_LINK_SAP primitives and is generic to any DL-only technology.

TABLE 1

| | Broadcast radio access technology |
|---|---|
| MIH_LINK_SAP Primitive | primitive |
| Link_Detected | Adjacent cell signal |
| Link_Up | Current signal strength |
| Link_Down | N/A |
| Link_Parameters_Report | LINK_PARAM_BCAST_GEN |
| Link_Going_Down | signal strength below a threshold |
| Link_Handover_Imminent | Current signal strength |
| Link_Handover_Complete | A primitive that indicates that handover |
| | to the broadcast technology is complete, |
| | e.g., an indication of good signal strength |
| | when connection is complete |
| Link_PDU_Transmit_Status | N/A |
| Link_Capability_Discover | N/A |
| Link_Event_Subscribe | N/A |
| Link_Event_Unsubscribe | N/A |
| Link_Get_Parameters | LINK_PARAM_BROADCST |
| Link_Configure_Thresholds | N/A |
| Link_Action | N/A |

The MIHF 102 may receive a primitive shown in the “Broadcast radio access technology primitive” column in Table 1 via an MIH_LINK_SAP. The MIHF 102 may then generate a corresponding MIH message based on the primitive. The MIHF 102 may communicate the generated message via the MIH_SA to MIH Users 122 and/or via the MIH NET SAP to the MIH Server 108. The LINK_PARAM_BCAST_GEN parameter generally follows the LINK_PARAM_GEN parameter defined in 802.21-2008 (21 Jan. 2009) Table F-4 and other related specifications.

In an instance where a link layer component implements DVB-H technology, it may provide link status information to the MIHF 102 as indicated below in Table 2.

TABLE 2

| MIH_LINK_SAP primitive | DVB-H primitive |
|---|---|
| Link_Detected | The receiver regularly monitors |
| | adjacent DVB-H cells signaled in the |
| | Network Information Table (NIT) |
| Link_Up | Transmission Parameter Signaling |
| | (TPS) in Physical Layer or Program |
| | Specific Information/Service |
| | Information (PSI/SI) |
| Link_Down | N/A |
| Link_Parameters_Report | Primitive related to NIT, PSI/SI, or |
| | FER/MFER |
| Link_Going_Down | FER or MFER |
| Link_Handover_Imminent | TPS in Physical Layer or PSI/SI |
| Link_Handover_Complete | The DVB-H handover is complete |
| Link_PDU_Transmit_Status | N/A |
| Link_Capability_Discover | N/A |
| Link_Event_Subscribe | N/A |
| Link_Event_Unsubscribe | N/A |
| Link_Get_Parameters | Primitive related to NIT, PSI/SI, or |
| | FER/MFER |
| Link_Configure_Thresholds | N/A |
| Link_Action | N/A |

The MIHF 102 may receive a primitive shown in the “DVB-H primitive” column in Table 2 via an MIH_LINK_SAP. The MIHF 102 may then generate a corresponding MIH message based on the primitive. The MIHF 100 may then communicate the generated message via the MIH_SA to MIH Users 122 and/or via the MIH_NET_SAP to the MIH Server 108.

Although FIG. 1 shows that the WTRU 100 includes two link layer components 130, 132, the WTRU 100 may include any number of additional link layer components (not depicted). The WTRU 100 may include additional SAPs (not depicted) analogous to the MIH_LINK_SAPs 110, 112, by which the MIHF 102 may communicate with the additional link layer components.

In an instance where the DL-only link layer component 130 implements DVB, the WTRU 100 may additionally include a Program Specific Information/Service Information (PSI/SI) module (not depicted) and an Electronic Service Guide (ESG) module (not depicted). For example, the PSI/SI parameters may be used by the DVB system to perform an intra-DVB handover. In the context of a handover from one DL-only technology to DVB, the PSI/PI parameters may be used to improve the handover to DVB.

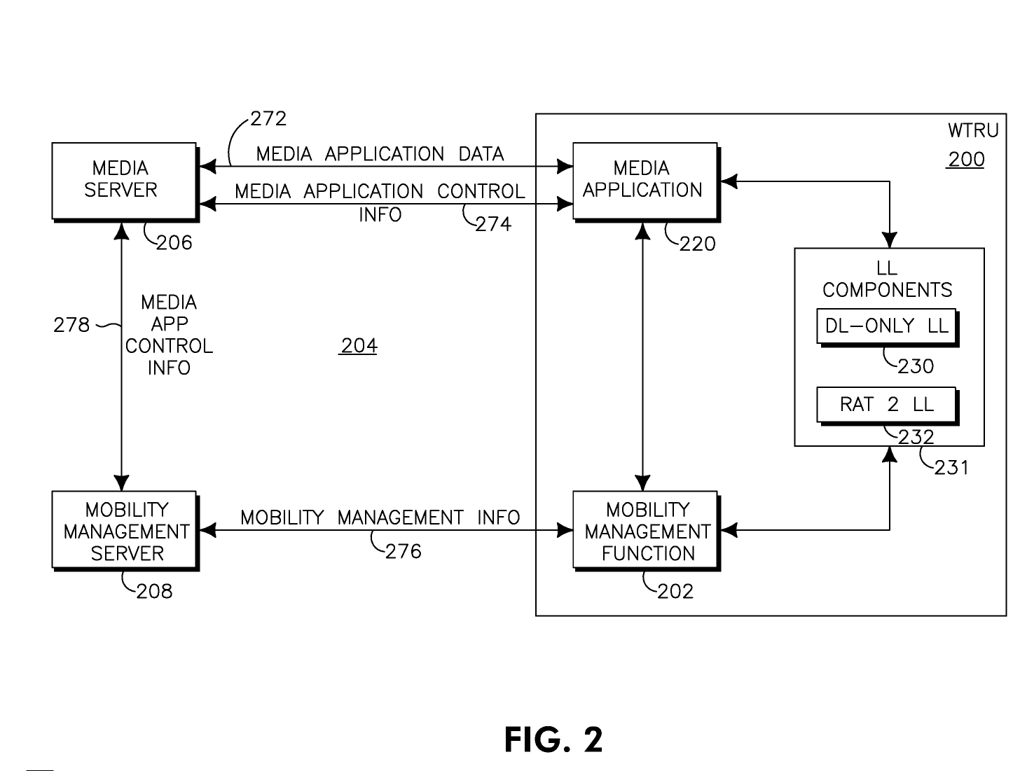

FIG. 2 shows a second example architecture 204 for the communication of media data in the context of DL-only communications. The example architecture 204 includes a WTRU 200, a media server 206, and a mobility management server 208. FIG. 2 shows logical channels for the communication of data: a DL channel 272; a return channel 274; a mobility management control channel 276; and media application information channel 278. These channels 272, 274, 276, 278 each represent a data path between their respective endpoints. These channels 272, 274, 276, 278, as described in further detail below, are independent of the wired or wireless technologies by which they are implemented.

The WTRU 200 includes link layer components 231 that include DL-only link layer component 230 and a second link layer component 232 that implements a bidirectional radio access technology. The link layer components 231 may include one or more additional link layer components (not depicted). The DL-only link layer component 230 may implement a radio access technology such as DMB, DBV, MediaFLO, or any other DL-only technology. The WTRU 200 may receive media data from the media server 206 via the DL channel 272. The DL channel 272 may be implemented, for example, on a radio access network to which the DL-only link layer component 230 is connected. The WTRU 200 may include a media application 220, which is capable of playing the received media data via a graphical and/or audio user interface.

The WTRU 200 may communicate control information related to the media application 220 to the media server 206 via return channel 274. The control information may include, for example, information that indicates the selection of a video-on-demand channel, a password required to access a service provided by the media server 206, information that indicates a vote for an interactive program, or other information. The return channel 274 may be implemented according to a bidirectional radio access technology; however the WTRU 200 may communicate control information related to the media application 220 to the media server 206 on the return channel 274 only in the UL direction. The return channel 274 may be implemented, for example, on a radio access network to which the second link layer component 232 is connected.

The WTRU 200 further includes a mobility management function 202, which may communicate mobility-related information with the mobility management server 208 via mobility management channel 276. The mobility management channel 276 may be implemented, for example, on a radio access network to which the second link layer component 232 is connected. The mobility management function 202 may receive link status information related to the access networks on which the DL channel 272, return channel 274, and/or the mobility management channel 276. The mobility management function 202 may receive the link status information via communications with the link layer components 231 on which the channels 272, 274, 276 are implemented. The link status information may indicate, for example, that QoS conditions have improved, become worse, and/or that a link is likely to go down. The mobility management function 202 may communicate notifications to the mobility management server 208 based on the received link status information.

The return channel 274 and the mobility management channel 276 maybe implemented on the same radio access network. Alternatively, these channels 274, 276 may be implemented on different radio access networks. In one example implementation of the architecture 204 of FIG. 2, the DL channel 272 may be implemented on a DL-only DMB radio access network, and the return channel 274 and the mobility management channel 276 may be implemented on a Code Division Multiple Access 2000 (CDMA2000) radio access network. As an additional example, the DL channel 272 may be implemented on a DL-only DBV radio access network, the return channel 274 may be implemented on a UMTS Terrestrial Radio Access Network (UTRAN), and the mobility management channel 276 may be implemented on a Wireless Local Area Network (WLAN).

Using the example architecture 204 of FIG. 2, handover of the DL channel 272 and/or the return channel 274 may be performed. The DL channel 272 may be handed over from its current radio access network to a number of different destination access networks. For example, the DL channel 272 may be handed over to the radio access network on which the return channel 274 is implemented, the radio access network on which the mobility management channel 276 is implemented, or a different radio access network. The destination radio access network for the DL channel 272 may be a DL-only radio access network, or may be a radio access network that supports both DL and UL communication.

Further, the return channel 274 may be handover over to a different radio access network. The return channel 274 may be handed over to, for example, a radio access network on which the mobility management channel 276 is implemented, a radio access network on which the DL channel 272 is implemented (if the radio access network supports UL communication), or to a different radio access network.

Further, the DL channel 272 and the return channel 274 may be handed over simultaneously. The DL channel 272 and the return channel 274 may be handed over the same radio access network, or may be handed over to different radio access networks. When handed over to the same radio access network, the destination radio access network may be the radio access network on which the mobility management channel 276 is implemented, or may be a different radio access network. When handed over to different radio access networks, either the DL channel 272 or the return channel 274 may be handed over to the radio access network on which the mobility management channel 276 is implemented; or, when handed over to different radio access networks, both the DL channel 272 and the return channel 274 may be handed over to different radio access networks that do not include the radio access network on which the mobility management channel 276 is implemented.

A handover such as those described above may be initiated by the mobility management function 202 of the WTRU 200 and/or by the mobility management server 208. A handover may be initiated at the WTRU 200 based on QoS conditions on the channels 272, 274 monitored by the mobility management function 202, and/or based on other factors. A handover may be initiated at the mobility management server 208 based on QoS condition information provided by the mobility management function 202 via the mobility management channel 276, based on factors related to load balancing, and/or based on other factors. When a handover is initiated by the mobility management server 208, the mobility management server 208 may send a handover request or command message to the mobility management function 202 via the mobility management channel 276 that indicates how the handover should be performed. Alternatively or additionally, the mobility management server 208 may send a handover request/command to the mobility management function 202 via the DL-only radio access network on which the DL channel 272 is implemented. A handover request/command, though transmitted via the mobility management channel 276, may therefore include information related to handover of links on different radio access networks other than the radio access network on which the handover command is sent.

In various implementations of the example architecture 204 of FIG. 2, multiple DL channels on DL-only radio access networks, in addition to or as an alternative to the DL channel 272, may exist between the media server 206 and the WTRU 200. Further, multiple UL return channels, in addition to or as an alternative to the return channel 274, may exist between the media server 206 and the WTRU 200. When multiple return channels are used, any number of the return channels (zero, one, or two or more) may share a radio access network with the mobility management channel 276. The above-described features related to the handover of the DL channel 272 and the return channel 274 may be employed, mutatis mutandis, to perform handover of DL channels and return channels in the context of multiple DL channels and/or return channels.

During a handover of the DL channel 272, the mobility management server 208 may receive information from the media server 206 via the media application information channel 278 that indicates how the media application 220 at the WTRU 200 should be configured after the DL channel 272 is handed over to a new radio access network. This information may indicate, for example, which media channel the media application 220 should tune to after the handover. The mobility management server 208 may communicate this information to the media application 220 at the WTRU 200 via the mobility management channel 276 and the mobility management function 202.

In various implementations of the example architecture 204 of FIG. 2, the mobility management function 202 and the mobility management server 208 may implement MIH features. In such instances, the mobility management server 208 may perform MIH server functionality and the mobility management function 202 in the WTRU 200 may perform MIHF functionality. For example, the mobility management function 202 may receive link status information related to the conditions of the radio access networks on which the channels 272, 274, 276 are implemented, and may send corresponding MIH notifications to the mobility management server 208. The corresponding MIH notifications may be, for example, MIH_Link_Detected, MIH_Link_Up, MIH_Link_Down, MIH_Link_Parameters_Report, MIH_Link_Going_Down, MIH_Link_Handover_Imminent, MIH_Link_Handover_Complete, MIH_Link_Handover_Complete, or other MIH messages. The handover commands sent by the mobility management server 208 to the mobility management function 202 may be, for example, MIH_Net_HO_Commit.request or other MIH messages.

In various implementations of the example architecture 204 of FIG. 2, the media server 206 and the mobility management server 208 may be implemented as separate devices. In such instances, the media application information channel 278 may be implemented via one or more wired or wireless networks. The one or more wired or wireless networks may include private networks and/or public networks such as the Internet. Alternatively, the media server 206 and mobility management server 208 may be implemented as a single device, or the functionality of both servers 206, 208 may be media application information channel 278 spread across two or more separate devices.

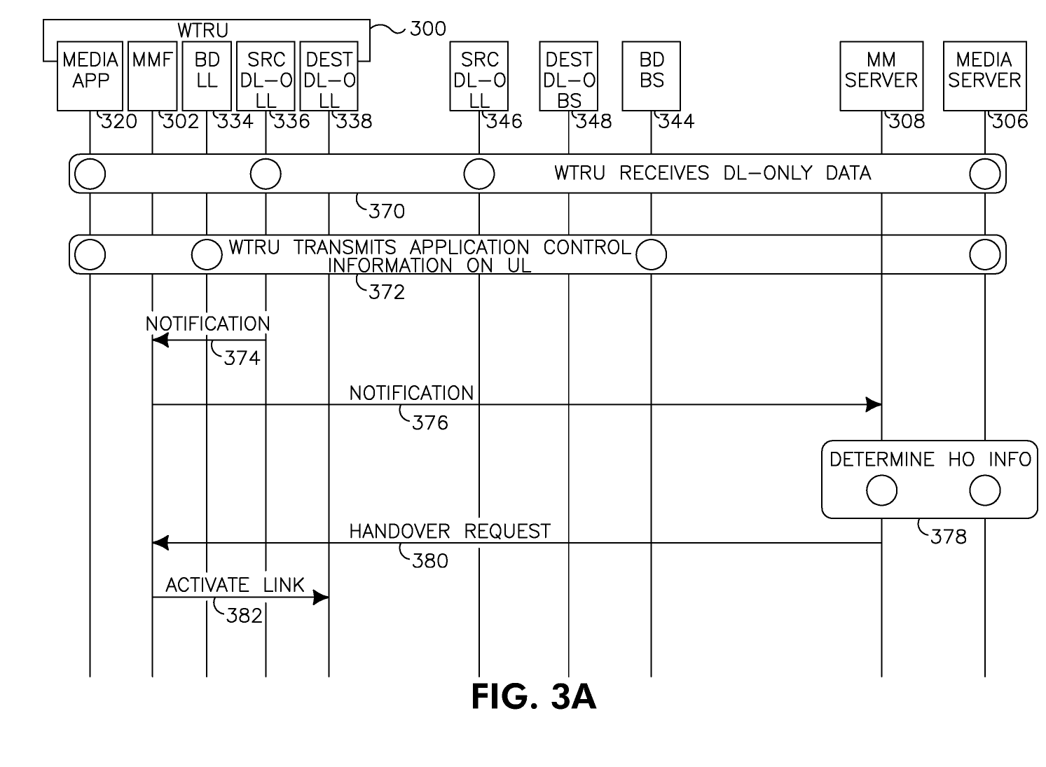

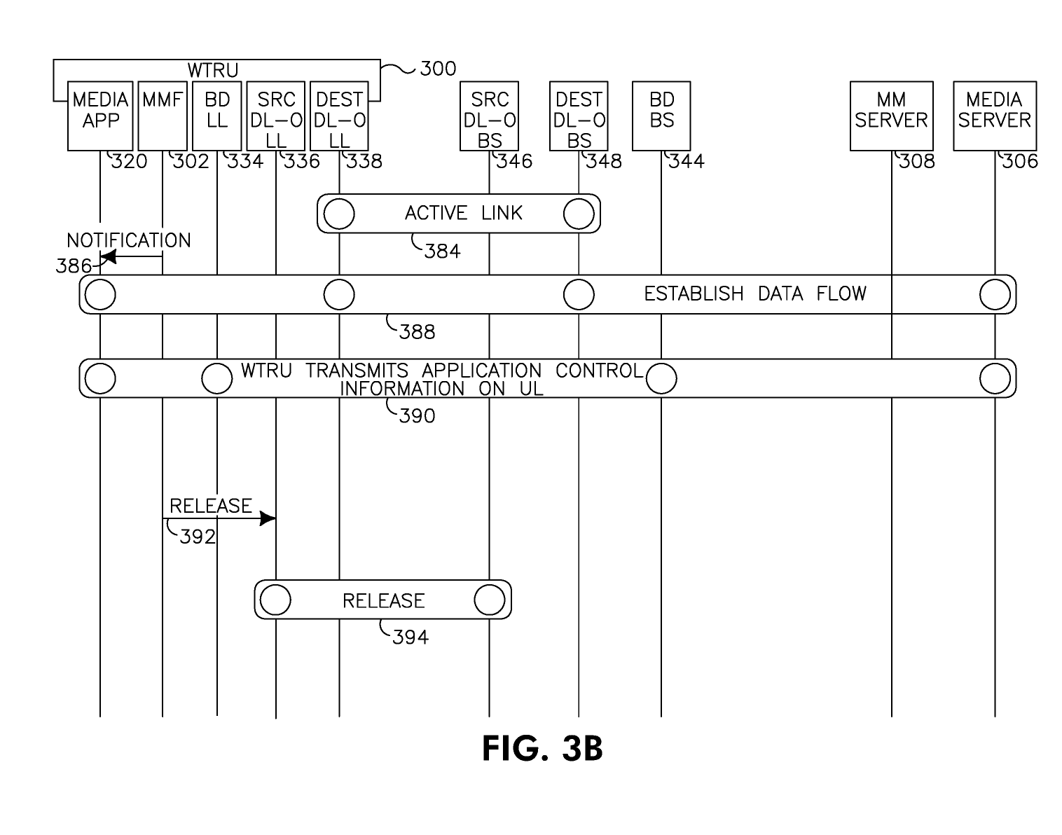

FIGS. 3A-3B show an example method for a handover of a DL-only link. FIGS. 3A-3B show a WTRU 300 that includes a media application 320, a mobility management function 302, a bidirectional link layer component 334, a source DL-only link layer component 336, and a destination DL-only link layer component 338. FIGS. 3A-3B further show a mobility management server 308, a media server 306, a bidirectional base station 344, a source DL-only base station 346, and a destination DL-only base station 348.

The method of FIGS. 3A-3B may begin as shown in FIG. 3A with the WTRU 300 receiving media data from the media server 306 (step 370). The source DL-only link layer component 336 may receive the media data via a radio access network provided by the source DL-only base station 346. The media application 320 at the WTRU 300 may play the media data via the user interface (not depicted) at the WTRU 300. The bidirectional link layer component 334 at the WTRU 300 may transmit control information for the media application 320 via the bidirectional base station 344 (step 372).

The source DL-only link layer component 336 may detect that QoS on the radio access network provided by the source DL-only base station 346 is degrading, and/or that the link failure on the network is imminent. In response, the source DL-only link layer component 336 may send a notification to the mobility management function 302 that indicate the detected change in QoS and/or that the link is going down (step 374).

In response to the notification from the SRC DL-only link layer 336, the mobility management function 302 in the WTRU 300 may then send a notification to the mobility management server 308 (step 376). This notification may include information such as the information received in the notification from the source DL-only link layer component 336. The WTRU 300 may send this notification to the mobility management server 308 via the bidirectional link layer component 334 and the bidirectional base station 344.

The mobility management server 308 may receive the notification and determine, in response to the notification, that the WTRU 300 should be handed over from the radio access network provided by the source DL-only link layer component 336 (step 378). The mobility management server 308 may also determine configuration information for the media application 320 that indicates how the media application 320 should be configured to continue receiving media data if a handover is performed to a new radio access network. For example, the mobility management server 308 may determine a new TV channel that the media application 320 should be tuned to in order to receive the same programming in a target radio access network. To determine this configuration information, the mobility management server 308 may exchange one or more messages with the media server 306. The media server 306 may, in response, communicate the configuration information to the mobility management server 308. The configuration information may indicate, for example, what TV channel the media application 320 should tune to in order to continue to receive the same TV program on a target radio access network. In this instance, the media server 306 maintains information such as, channels and times, with respect to specific programs and how to obtain the specific programs on different technologies. This may be maintained on a per program basis. The media server 306 may send the same configuration information to all WTRUs for a particular program. The configuration information may also include synchronization information and/or other information that may indicate, for example, that the DL-only signal has been correctly received.

The mobility management server 308 may then initiate a handover from the radio access network provided by the source DL-only link layer component 336 by sending a handover request message to the mobility management function 302 at the WTRU 300 (step 380). The mobility management server 308 may send the handover request message via the bidirectional base station 344. The handover request message may include the configuration information for the media application 320 received from the media server 306 and an identifier of the target access network and/or target radio access technology.

In response to the handover request message, the mobility management function 302 may activate the destination DL-only link layer component 338 (step 382). This may be performed by, for example, the mobility management function 302 sending one or more primitives to the destination DL-only link layer component 338 indicating that the destination DL-only link layer component 338 should power on and/or establish a new connection.

Referring to FIG. 3B, the destination DL-only link layer component 338 may communicate with the destination DL-only base station 348 to establish a connection (step 384). This may include, for example, the source DL-only link layer component 336 and the destination DL-only base station 348 exchanging one or more registration, association, and/or authentication messages.

The mobility management function 302 may send a notification to the media application 320 that indicates the new link that has been established (step 386). The notification may also indicate that the media application 320 should receive media data via the new link on the destination DL-only link layer component 338. The notification may also include the configuration information received from the mobility management server 308.

The media application 320 may then adjust its configuration and begin to receive media data via the new link on the destination DL-only link layer component 338 (step 388). This may include, for example, tuning to a new TV channel as indicated in the configuration information. The media application 320 may play the media data via a user interface (not depicted) at the WTRU 300. The bidirectional link layer component 334 at the WTRU 300 may transmit control information for the media application 320 to the media server 306 via the bidirectional base station 344 (step 390).

Once the link is established on the destination DL-only link layer component 338, the mobility management function 302 may release the connection on the source DL-only link layer component 336 (step 392). This may be performed by, for example, the mobility management function 302 sending one or more primitives to the source DL-only link layer component 336 indicating that the source DL-only link layer component 336 should power of and/or release its connection. The source DL-only link layer component 336 may then perform a release procedure (step 394) with the source DL-only base station 346 to release resources allocated by the source DL-only base station 346 for the WTRU 300. This may involve, for example, the exchange of one or more deregistration or disassociation messages between the WTRU 300 and the source DL-only base station 348.

Although FIGS. 3A-3B show that information is communicated between the WTRU 300 and the mobility management server 308 and media server 306 via the same base station (bidirectional base station 344), in various implementations of the method of FIGS. 3A-3B, different radio access networks may be used to communicate data between the WTRU 300 and the mobility management server 308 and media server 306.

In various implementations of the method of FIGS. 3A-3B, the mobility management function 302 and the mobility management server 308 may implement MIH features. In such instances, the mobility management server 308 may perform MIH server functionality and the mobility management function 302 in the WTRU 300 may perform MIHF functionality, and message exchange between the mobility management server 308 and the mobility management function 302 may be MIH messages. The method of FIGS. 3A-3B may be performed using the example architecture 104 of FIG. 1, the example architecture 204 of FIG. 2, and/or any other appropriate network architecture.

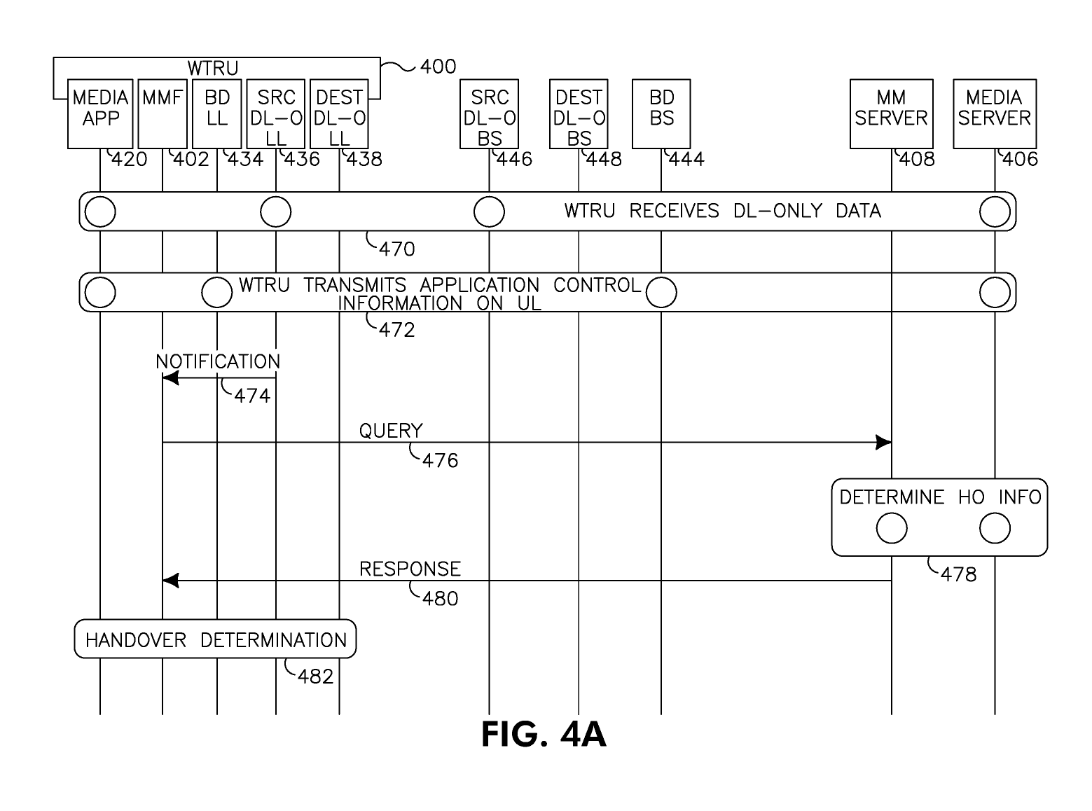

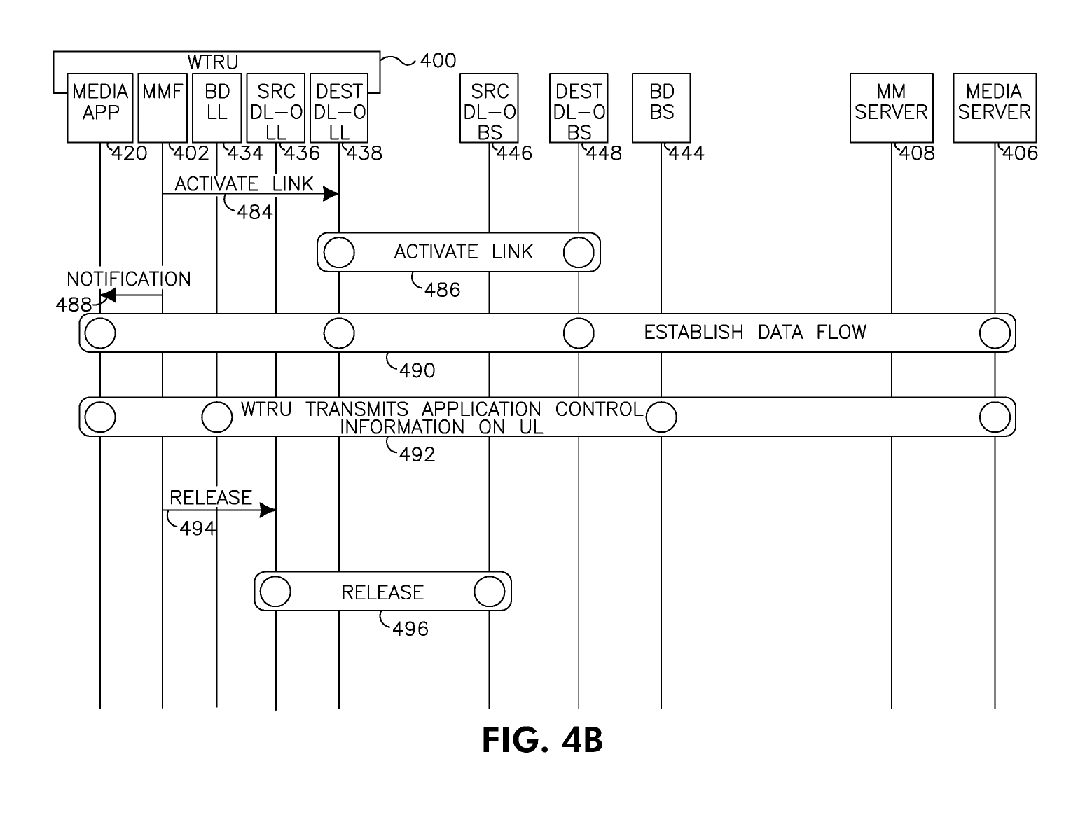

FIGS. 4A-4B show a second example method for a handover of a DL-only link. FIGS. 4A and 4B show a WTRU 400 that includes a media application 420, a mobility management function 402, a bidirectional link layer component 434, a source DL-only link layer component 436, and a destination DL-only link layer component 438. FIGS. 4A and 4B further show a mobility management server 408, a media server 406, a bidirectional base station 444, a source DL-only base station 446, and a destination DL-only base station 448.

The method of FIGS. 4A-4B may begin as shown in FIG. 4A with the WTRU 400 receiving media data from the media server 406 (step 470). The source DL-only link layer component 436 may receive the media data via a radio access network provided by the source DL-only base station 446. The media application 420 at the WTRU 400 may play the media data via the user interface (not depicted) at the WTRU 400. The bidirectional link layer component 434 at the WTRU 400 may transmit control information for the media application 420 via the bidirectional base station 444 (step 472).

The source DL-only link layer component 436 may detect that QoS on the radio access network provided by the source DL-only base station 446 is degrading, and/or that the link failure on the network is imminent. In response, the source DL-only link layer component 436 may send a notification to the mobility management function 402 that includes link status information (step 474). The link status information may indicate the detected change in QoS and/or that the link is going down.

The mobility management function 402 at the WTRU 400 may send a query message to the mobility management server 408 (step 476). The query message may indicate a request for information related to radio access networks that are available for handover. The query message may indicate a request for information related specifically to DL-only radio access networks. Alternatively or additionally, the query message may indicate a request for configuration information related to how the media application 420 should be configured to continuously receive media data if the WTRU 400 performs a handover to another radio access network. The WTRU 400 may send the query message based on the notification received from the source DL-only link layer component 436.

In response to the query, the mobility management server 408 may determine DL-only radio access networks that are available to the WTRU 400 for handover of the DL-only link (step 478). The mobility management server 408 may also determine configuration information for the media application 420 that indicates how the media application 420 should be configured to continue receiving media data if a handover is performed to a new radio access network. To determine this configuration information, the mobility management server 408 may exchange one or more messages with the media server 406. This exchange of messages may include the mobility management server 408 transmitting a query message to the media server 406 information that indicates what radio access technologies the WTRU 400 supports and/or what radio access networks are available. The media server 406 may, in response, communicate the configuration information to the mobility management server 408. The configuration information may indicate, for example, what TV channel the media application 420 should tune to in order to continue to receive the same TV program on a target radio access network. The configuration information may also include synchronization information and/or other information.

The mobility management server 408 may then send a response message to the mobility management function 402 at the WTRU 400 (step 480). The response may include information that identifies potential target radio access networks and corresponding configuration information for the media application 420.

The WTRU 400 may make a determination to perform a handover based on the information included in the response message (step 482). The determination may be, for example, to perform a handover to a radio access network to which the destination DL-only link layer component 438 can connect. The determination may be performed, for example, at an upper-layer handover application (not depicted) or other application or module (not depicted) at the WTRU 400.

Referring to FIG. 4B, the WTRU 400 may activate the destination DL-only link layer component 438 (step 484). This may be performed by, for example, the mobility management function 402 sending one or more primitives to the destination DL-only link layer component 438 indicating that the destination DL-only link layer component 438 should power on and/or establish a new connection.

Referring to FIG. 4B, the destination DL-only link layer component 438 may communicate with the destination DL-only base station 448 to establish a connection (step 486). This may include, for example, the source DL-only link layer component 436 and the destination DL-only base station 448 exchanging one or more registration, association, and/or authentication messages.

The mobility management function 402 may send a notification to the media application 420 that indicates the new link that has been established (step 488). The notification may also indicate that the media application 420 should receive media data via the new link on the destination DL-only link layer component 438. The notification may also include the configuration information received from the mobility management server 408.

The media application 420 may then adjust its configuration and begin to receive media data via the new link on the destination DL-only link layer component 438 (step 490). This may include, for example, tuning to a new TV channel as indicated in the configuration information. The media application 420 may play the media data via a user interface (not depicted) at the WTRU 400. The bidirectional link layer component 434 at the WTRU 400 may transmit control information for the media application 420 to the media server 406 via the bidirectional base station 444 (step 492).

Once the link is established on the destination DL-only link layer component 438, the mobility management function 402 may release the connection on the source DL-only link layer component 436 (step 494). This may be performed by, for example, the mobility management function 402 sending one or more primitives to the source DL-only link layer component 436 indicating that the source DL-only link layer component 436 should power off and/or release its connection. The source DL-only link layer component 436 may then perform a release procedure (step 494) with the source DL-only base station 446 to release resources allocated by the source DL-only base station 446 for the WTRU. This may involve, for example, the exchange of one or more deregistration or disassociation messages between the WTRU 400 and the source DL-only base station 446.

Although FIGS. 4A-4B show that information is communicated between the WTRU 400 and the mobility management server 408 and media server 406 via the same base station (bidirectional base station 444), in various implementations of the method of FIGS. 4A-4B, different radio access networks may be used to communicate data between the WTRU 400 and the mobility management server 408 and media server 406.

Alternatively or additionally, in various implementations of the method of FIGS. 4A-4B, the mobility management function 402 and the mobility management server 408 may implement MIH features. In such instances, the mobility management server 408 may perform MIH server functionality and the mobility management function 402 in the WTRU 400 may perform MIHF functionality, and message exchange between the mobility management server 408 and the mobility management function 402 may be MIH messages. The method of FIGS. 4A-4B may be performed using the example architecture 104 of FIG. 1, the example architecture 204 of FIG. 2, and/or any other appropriate network architecture. Alternatively or additionally, a communications system may implement any feature or sub-feature of the method of FIG. 3A-3B, the method of FIGS. 4A-4B, and/or any combination of the methods of FIGS. 3A-3B and FIGS. 4A-4B.

An MIH message may include a Destinationldentifier field that indicates a MIHF that is the intended recipient of the message. MIH messages that include a DestinationIdentifier field include but are not limited to the MIH_Event_Subscribe.request, MIH_Link_Get_Parameters.request, MIH_Link_Configure_Thresholds.request, MIH_Net_HO_Candidate_Query.request, MIH_MN_HO_Candidate_Query.request, MIH_MN_HO_Commit.request, MIH_Net_HO_Commit.request, MIH_Get_Information.request, and MIH_Push_Information.request messages. When an MIHF receives an MIH message that includes a DestinationIdentifier field, the MIHF determines whether the value in the DestinationIdentifier field matches the identifier of the MIHF to determine whether the MIH message is intended for the MIHF.

An MIH message may additionally include a Secondary MIHF IDs field. The Secondary MIHF IDs field may include a list of MIHF identifiers. When an MIHF receives an MIH message that includes a Secondary MIHF IDs field, the MIHF may keep these secondary MHF IDs locally and accept any message specifying one of these MIHF IDs, as if the message was destined to the MIHF.

The multicast subscription mechanism may use the Secondary MIHF IDs. The MIHF may subscribe to multicast groups or the MIH server may register a MIHF to multicast groups. These groups may be exchanged using Secondary MIHF IDs. MIHF must keep the multicast groups IDs locally to match them to the received messages. The multicast messages sent by the MIH server specify the multicast group(s) either in the regular (primary) MIHF ID field or in the Secondary MIHF IDs field. The MIHF receiving a multicast message compares the primary MIHF ID and/or secondary MIHF IDs with the ones it has kept locally (subscribed groups+its own MIHF ID). If there's a match, the message is processed.

An MIH server may define a broadcast or multicast group that includes a number of WTRUs. The MIH server may generate an MIH message that includes an identifier of the broadcast or multicast group in a Secondary MIHF IDs field, and then broadcast or multicast the message. An MIH server may multicast an MIH message via a Layer-Two specific mechanism, such as a Media Access Control (MAC) multicast value. Alternatively or additionally, an MIH server may broadcast an MIH message using a Layer-Two specific mechanism such an IEEE 802.11 beacon frame. When WTRUs receive the MIH message, they can determine, based on the contents of the MIHF ID field or Secondary MIHF IDs fields, whether the message is intended for a group of which they are a member.

Broadcast or multicast group identifiers may be provided to WTRUs via a number of different mechanisms. For example, an MIH server may advertise group identifiers during registration of a WTRU or via a capability discovery mechanism. Alternatively or additionally, group identifiers may be pre-defined. For example, multicast groups supported by the server may be advertised to the users during registration/capability discovery. The user may decide, from the supported multicast groups, which ones are of interest. In another example, the operator may hardcode the information based on the device model, type of plan or other similar criteria. In another example, multicast groups may be provided based on a combination of any of the above including hardcoding, user preferences and server decisions. Group identifiers may be defined for WTRUs that are capable of communicating using the same access technologies or according to other criteria. For example, a “WLAN Group” identifier may be used to identify a group of WTRUs that are capable of communicating using WLAN technology.

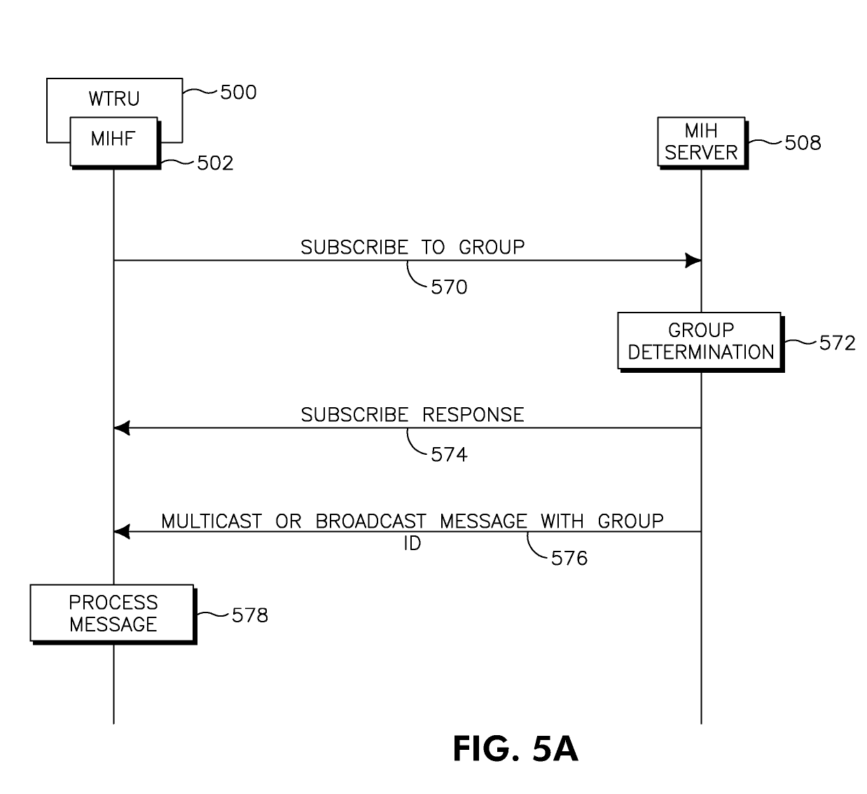

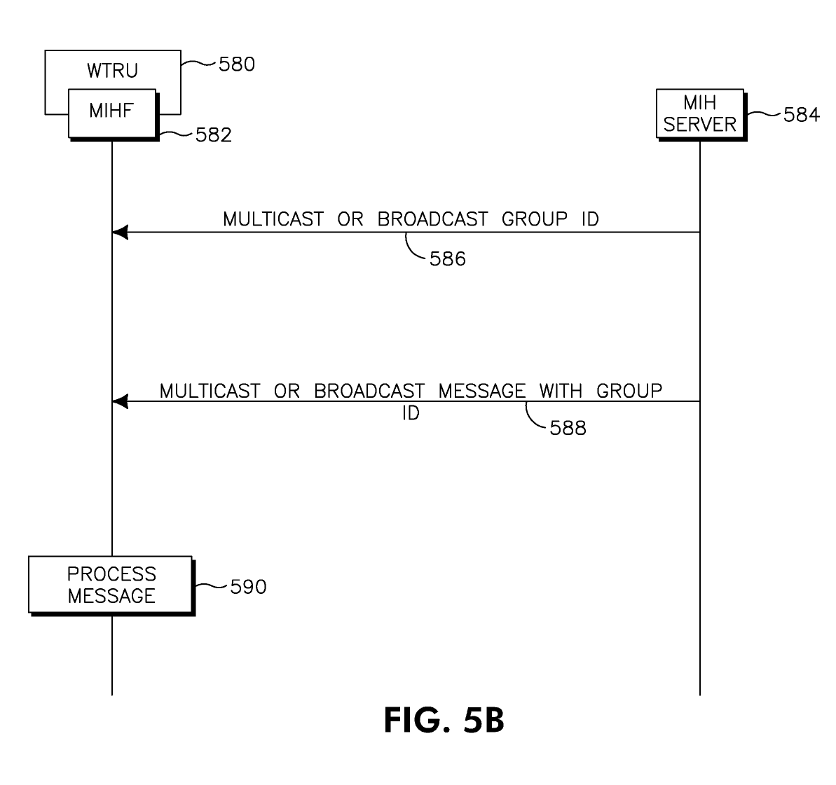

FIG. 5A shows a method for the communication of data that includes the use of an MIH broadcast or multicast message. FIG. 5A shows a WTRU 500 that includes an MIHF 502. FIG. 5 also shows an MIH server 508, which is in communication with the WTRU 500.

The MIHF 502 at the WTRU 500 may send a message to the MIH server 508 to subscribe to a broadcast or multicast group (step 570). The message may be, for example, an MIH_Register.request, MIH_Capability_Discover.request, or MIH_Event_Subscribe.request message. The message may include an identifier of a broadcast or multicast group that the WTRU 500 wishes to join. The identifier may be an identifier that the WTRU 500 discovered during a registration with the MIH server 508, or may be a pre-defined identifier. Alternatively or additionally, the message may indicate capability information for the WTRU 500. The capability information may indicate, for example, radio access technologies supported by the WTRU 500.

The MIH server 508 may determine which broadcast or multicast groups to subscribe the WTRU 500 to (step 572). This determination may be based on a group identifier sent by the WTRU 500, the capability information sent by the WTRU 500, and/or one or more other parameters. For example, if the WTRU indicated that it supports WLAN technology (step 570), the MIH server 508 may determine that the WTRU 500 should be added to a group of WTRUs that support WLAN technology. The group may have an identifier such as “WLAN Group.”

The MIH server 508 may then send a response message to the MIHF 502 at the WTRU 500 (step 572). The response message includes one or more fields that indicate the identifiers of one or more broadcast or multicast groups to which the WTRU 500 is now subscribed. The one or more fields may be or include information element (IE) List Type Length Value (TLV) fields. The response message may be an MIH_Register.response, MIH_Capability_Discover.response, MIH_Event_Subscribe.response, or MIH_Push_Information message, or other MIH message. In an example where the MIH server determines that the WTRU 500 should be added to the “WLAN Group,” the response message may include the “WLAN Group” identifier.

The MIH server 508 may send a broadcast or multicast MIH message that includes a MIHF ID and/or Secondary MIHF IDs fields that indicate one or more multicast or broadcast groups to which the MIH message is intended (step 576). The MIHF 502 at the WTRU 500 may receive and process the MIH message to determine if the message is intended for the WTRU 500 (step 578). The MIHF 502 may do so by comparing values in the MIHF IDs fields to identifiers of broadcast or multicast groups of which the WTRU 500 is a member. In an example where the WTRU 500 is in the “WLAN Group,” the MIHF 502 would analyze each of the identifiers in the MIHF ID and/or Secondary MIHF IDs fields in the MIH message to determine if the MIH message was intended for the “WLAN Group.” If the MIHF 502 determines that the MIH message is intended for the WTRU 500, the MIHF 502 may respond as indicated in the message. For example, if the MIH message requests a handover or other action, the MIHF 502 may perform the requested handover or other action.

As shown in FIG. 5A, a WTRU may register with an MIH server in order to subscribe to a broadcast or multicast group. Alternatively or additionally, an MIH server 584 may assign a WTRU 580 to a group using a push mechanism as shown in FIG. 5B. This example method may be used for devices have DL-only capability. In this instance, the devices may not be registered with a server and cannot subscribe to a multicast group. Although the devices may receive messages destined to the multicast group “ALL MIHF” (e.g. hardcoded to all devices), this method allows the server to configure other multicast groups for this device by pushing multicast subscriptions to the device using the “ALL MIHF” as a destination MIHF ID (e.g. pushing a information service message containing secondary MIHF IDs). The MIH server 584 may do so by sending a message to the WTRU 580 that indicates that the WTRU 580 is a member of a broadcast or multicast group (step 586). The message may include an identifier of the group to which the WTRU 580 is being assigned. When the WTRU 580 later receives a broadcast or multicast message that includes a MIHF ID and/or Secondary MIHF IDs fields (step 588), the WTRU 580 may determine whether the message is intended for the WTRU 580 based on the group identifiers in the MIHF ID and/or Secondary MIHF IDs fields and the identifiers of groups to which the WTRU 580 has been assigned (step 590). The broadcast or multicast message may be a message defined according to the MIH Information Service, or any other MIH message.

The above-described features related to the use of multicast or broadcast group identifiers may be used in the context of bidirectional radio access technologies, and may also be used in the context of DL-only technologies, such as but not limited to DVB-H, DVB-T, or MediaFLO technology. Through these features, an MIH server may, for example, initiate the handover of multiple WTRUs that use a DL-only technology. An MIH server may do so by defining a group that includes all of the WTRUs that use a given DL-only technology and registering the WTRUs with the group. The MIH server may then send an MIH handover request message with a MIHF ID and/or Secondary MIHF IDs fields that includes a group identifier corresponding to the group.

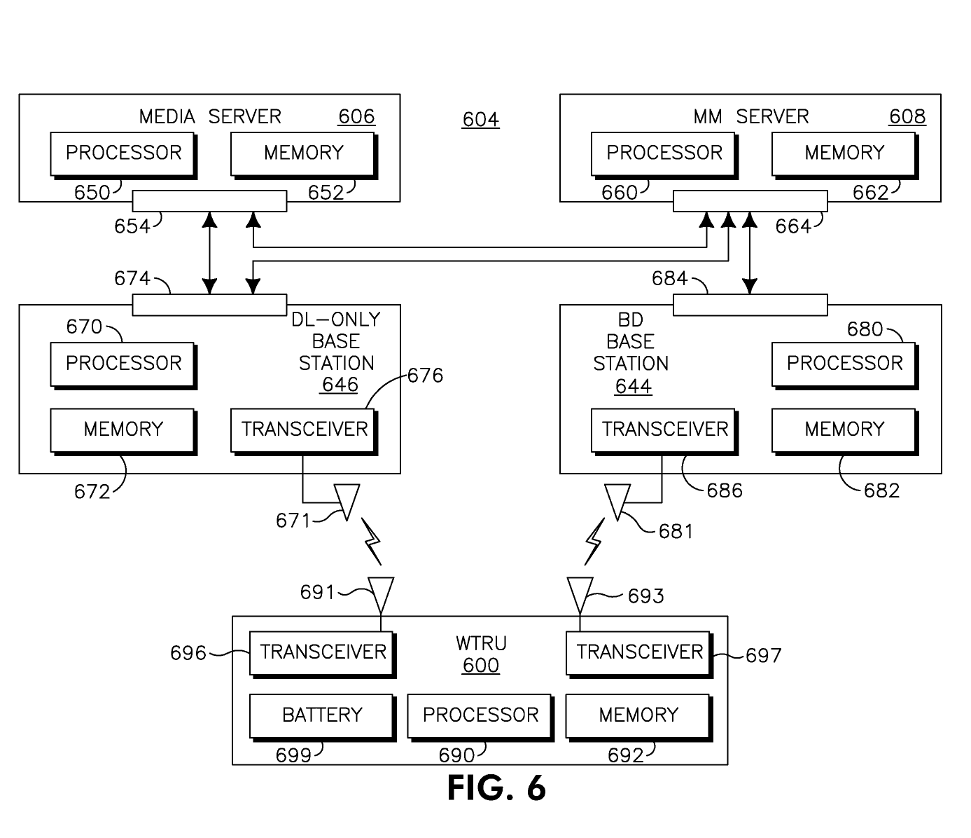

FIG. 6 shows an example communications system 604 that may be configured to implement the features and methods described above with reference to FIGS. 1-5. The example communications system 604 may include a WTRU 600, a DL-only base station 646, a bidirectional base station 644, a mobility management server device 608, and a media server device 606.

In addition to the component that may be found in a typical WTRU, the WTRU 600 may include a processor 690, a linked memory 692, a battery 699, a first transceiver 696 that is capable of communicating using a DL-only radio access technology, a first antenna 691, a second transceiver 697 that is capable of communicating using a bidirectional radio access technology, and a second antenna 693. The processor 690 may be configured to generate and/or process messages and other data as described above with reference to FIGS. 1-5. The processor 690 and linked memory 692 may be configured to perform the functionality attributed to any MIHF or mobility management function in a WTRU described above with reference to FIGS. 1-5. The first transceiver 696 and the second transceiver 697 may be in communication with the processor 690 to facilitate the transmission and/or reception of wireless data. The first transceiver 696 may receive wireless data using one or more technologies such as DMB, DVB, MediaFLO, or other DL-only technologies. The first transceiver 696 may receive wireless data via the first antenna 691. The second transceiver 796 may be capable of communicating wireless data using one or more technologies such as UTRAN, Long Term Evolution (LTE), Service Architecture Evolution (SAE), Evolved UTRAN (E-UTRAN), IEEE 802.11, CDMA2000, Global System for Mobile Communications (GSM), GSM Enhanced Data Rates For GSM Evolution (EDGE) Radio Access Network (GERAN), IEEE Worldwide Interoperability for Microwave Access (WiMax), Wireless Broadband (WiBro), LTE Advanced (LTE-A), or other technologies. The second transceiver 697 may transmit and/or receive wireless data via the second antenna 693. The battery 699 may power the first transceiver 696, the second transceiver 697, the processor 690, and/or the linked memory 692. The WTRU 600 may be configured to perform any feature or combination of features attributed to any WTRU or combination of WTRUs described above with reference to FIGS. 1-5. Although the WTRU 600 is shown as including two transceivers and two antennas, any combination of single- or multi-mode transceivers and antennas may be used to implement the WTRU 600.

In addition to the components that may be found in a typical base station, the DL-only base station 646 may include a processor 670, a linked memory 672, a transceiver 676, and an antenna 671. The transceiver 676 may be in communication with the processor 670 to facilitate the transmission of wireless data. The transceiver 676 may transmit wireless data via the antenna 671. The DL-only base station 646 may additionally include a communications interface 674. The communications interface 674 may be configured to transmit and/or receive data from the media server device 606, the mobility management server 608 and/or other network nodes (not depicted).The DL-only base station 646 may be configured to perform any feature or combination of features attributed to any DL-only base station or combination of DL-only base stations described above with reference to FIGS. 1-5.

In addition to the components that may be found in a typical base station, the bidirectional base station 644 may include a processor 680, a linked memory 682, a transceiver 686, and an antenna 681. The transceiver 686 may be in communication with the processor 680 to facilitate the transmission and/or reception of wireless data. The transceiver 686 may transmit and/or receive wireless data via the antenna 681. The bidirectional base station 644 may additionally include a communications interface 684. The communications interface 684 may be configured to transmit and/or receive data from the mobility management server device 608 and/or other network nodes (not depicted). The bidirectional base station 644 may be configured to perform any feature or combination of features attributed to any bidirectional base station or combination of bidirectional base stations described above with reference to FIGS. 1-5.

The mobility management server device 608 may include a processor 660 and a memory 662. The processor 660 may be configured to generate and/or process messages and other data as described above with reference to the mobility management servers and/or MIH servers described above in FIGS. 1-5. The mobility management server device 608 may additionally include a communications interface 684. The communications interface 684 may be configured to transmit and/or receive data from the media server device 606, bidirectional base station 644, and/or other network nodes (not depicted). The mobility management server device 608 may be configured to perform any feature or combination of features attributed to any mobility management server, MIH server, or combination of mobility management servers and MIH servers described above with reference to FIGS. 1-5.

The media server device 606 may include a processor 650 and a memory 652. The processor 650 may be configured to generate and/or process messages and other data as described above with reference to the media servers described above with reference to FIGS. 1-5. The media server device 606 may additionally include a communications interface 654. The communications interface 654 may be configured to transmit and/or receive data from the mobility management server device 608, DL-only base station 646, and/or other network nodes (not depicted). The media server device 606 may be configured to perform any feature or combination of features attributed to any media server or combination of media servers described above with reference to FIGS. 1-5.

Each or any of the communications interfaces 654, 664, 674, 684 may operate using wired or wireless communications technology, and/or may be or include a transceiver. Each or any of the communications interfaces 654, 664, 674, 684 may be capable of communicating using technologies such as, for example, Ethernet, Carrier Ethernet, fiber optics, microwave, xDSL (Digital Subscriber Line), Asynchronous Transfer Mode, (ATM), Signaling System 7 (SS7), Internet Protocol (IP), and/or IP/Multiprotocol Label Switching (MPLS).

Although examples are provided above with reference to FIGS. 1-6 in terms of media data, the above-described principles are equally applicable, mutatis mutandis, to any other type of data that may be communicated using broadcast, multicast, DL-only, and/or other data communication technology. Although examples are provided above with reference to FIGS. 1-6 in terms of DL-only technology, the above-described principles are equally applicable, mutatis mutandis, in communications systems that do not include the use of DL-only technology.

Although features and elements are described above in particular combinations, each feature or element may be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for use in a wireless transmit/receive unit (WTRU), the method comprising:
generating link status information related to conditions on a radio link on a downlink-only radio access network; and
sending a link status information message to a mobility management server, wherein the link status information message includes the link status information and includes a field that indicates that the link status information relates to a downlink-only radio access network.

2. The method of claim 1 wherein the mobility management server is a Media Independent Handover (MIH) server and wherein the link status information message is an MIH message, an MIH_Link_Up.indication message, an MIH_Link_Down.indication message, an MIH_Link_Parameters_Report.indication message, an MIH_Link_Going_Down.indication message, an MIH_Link_Handover_Imminent.indication message, an MIH_Link_Handover_Complete.indication message, or an MIH_Link_PDU_Transmit_Status.indication message.

3. The method of claim 2 wherein the field that indicates that the link status information relates to a downlink-only radio access network is one of a LINK_TYPE field or a LINK_DIRECTION field.

4. The method of claim 3 wherein the LINK_TYPE field indicates a radio access technology on which the downlink-only radio access network is based.

5. The method of claim 3 wherein the LINK_DIRECTION field indicates a DL_ONLY value.

6. The method of claim 1 wherein the link status information is sent over a bi-directional link.

7. A wireless transmit/receive unit (WTRU) comprising:
a link layer component configured to generate link status information related to conditions on a radio link on a downlink-only radio access network; and
a transmitter configured to transmit a link status information message to a mobility management server, wherein the link status information message includes the link status information and includes a field that indicates that the link status information relates to a downlink-only radio access network.

8. The WTRU of claim 7 wherein the mobility management server is a Media Independent Handover (MIH) server and wherein the link status information message is an MIH message, an MIH_Link_Up.indication message ,an MIH_Link_Down.indication message, an MIH_Link_Parameters_Report.indication message, an MIH_Link_Going_Down.indication message, an MIH_Link_Handover_Imminent.indication message an MIH_Link_Handover_Complete.indication message, or an MIH_Link_PDU_Transmit_Status.indication message.

9. The WTRU of claim 8 wherein the field that indicates that the link status information relates to a downlink-only radio access network is one of a LINK_TYPE field or a LINK_DIRECTION field.

10. The WTRU of claim 9 wherein the LINK_TYPE field indicates a radio access technology on which the downlink-only radio access network is based.

11. The WTRU of claim 9 wherein the LINK_DIRECTION field indicates a DL_ONLY value.

12. A method for use in a wireless transmit/receive unit (WTRU), the method comprising:
receiving media data from a media server via a link on a downlink-only radio access network;
playing the media data in a media application;
receiving a handover request message from a mobility management server in response a link status information sent by the WTRU, wherein the handover request message indicates that the WTRU should handover to a second radio access network and includes configuration information that indicates how the media application should be configured once the media data is received via the second radio access network; and
receiving the media data from the media server via a link on the second radio access network and playing the media data in the media application based on the configuration information.

13. The method of claim 12 wherein the second radio access network is one of a downlink-only radio access network or a bidirectional radio access network.

14. The method of claim 12 wherein the mobility management server is a Media Independent Handover (MIH) server and wherein the handover request message is an MIH message.

15. The method of claim 12 wherein the handover request message is an MIH_Net_HO_Commit.request message.

16. The method of claim 12 wherein the configuration information indicates one or more of: a television channel to which the media application should tune; and synchronization information.

17. A method for use in a wireless transmit/receive unit (WTRU), the method comprising:
receiving a multicast message;
comparing a primary identifier and at least one secondary identifier in the multicast message against stored identifiers, wherein the at least one secondary identifier corresponds to a multicast group identity; and
processing the multicast message on a condition that at least one of the primary identifier or the at least one secondary identifier matches the stored identifiers.

18. The method of claim 17 wherein the WTRU subscribes to multicast group identities through at least one of registration, capability discovery, predefined, hardcoded, plan specific, device specific, and user preferences.

19. The method of claim 17 further comprising:
receiving a message indicating which multicast groups the WTRU belongs to; and
the WTRU storing multicast group identifiers corresponding to the multicast groups.

20. The method of claim 17 further comprising sending a subscription message to register for multicast groups.
